(19) United States
(12) Patent Application Publication
(10) Pub. No.: US 2026/0073912 A1
(43) Pub. Date: Mar. 12, 2026

(54) Eternity Chat: AI-Driven System Configured to Provide User Simulation Conversation with Deceased Individuals

(71) Applicant: Cyrus Vahabzadeh Manesh, Bryan, TX (US)

(72) Inventor: Cyrus Vahabzadeh Manesh, Bryan, TX (US)

(21) Appl. No.: 19/302,046

(22) Filed: Aug. 17, 2025

Related U.S. Application Data
(60) Provisional application No. 63/692,778, filed on Sep. 10, 2024.

(51) Int. Cl. G10L 15/18; G10L 13/027; G10L 13/047; G10L 15/30; G10L 25/63

(52) U.S. Cl. CPC G10L 15/1815; G10L 13/027; G10L 13/047; G10L 15/30; G10L 25/63

(57) ABSTRACT

An AI-driven and machine learning system provides users with simulated conversations with deceased individuals. Users may interact with an AI module that reproduces both the voice and persona of a deceased loved one. The system integrates an AI algorithm, a machine learning module, a sentiment analysis component, a voice cloning module, a natural language processing and generation engine, a multimodal interaction module, a data input interface, a user interface, cloud storage, a real-time processing unit, multiple security protocols, and API integrations to external third-party services and databases. Unlike existing solutions, the system functions as a hub that combines proprietary and third-party technologies, continuously learning from user-provided data and prior interactions to deliver emotionally resonant, contextually accurate responses in real time. The architecture supports flexible component substitution, enabling integration with evolving external AI, sentiment, or voice technologies while maintaining personalized, secure, and seamless user experiences.

### BACKGROUND OF THE INVENTION

The embodiments herein relate generally to AI-mediated communication, and more particularly to a system configured as a hub/platform that integrates proprietary and third-party technologies to provide simulated conversations with deceased individuals.

Existing AI conversation systems are often generalized and lack the capacity to operate within a personalized, emotionally relevant context. Voice cloning technologies frequently produce speech without genuine sentiment or emotional nuance. As a result, responses can feel generic and disconnected from the unique personality of the individual being simulated.

Therefore, there is a need for a system that combines sentiment analysis, persona modeling, voice synthesis, and memory of prior interactions into a unified platform, enabling more authentic and emotionally resonant simulated conversations.

### SUMMARY OF THE INVENTION

The present invention provides a system configured to deliver a virtual conversation experience with deceased individuals by integrating various AI and machine learning components through a centralized hub. This hub allows the combination of custom-developed modules—such as a proprietary sentiment analysis engine—and existing third-party technologies—such as voice cloning services or external vector databases—into a seamless, real-time simulation platform.

In one embodiment, the system includes:
An AI Algorithm Module for natural language understanding and response generation.
A Machine Learning Module for adaptive conversation refinement.
A Proprietary Sentiment Analysis Component to embed emotional tone and context into responses.
An Integrated Voice Cloning Service (third-party or proprietary) to replicate the speech patterns of a deceased individual.
A Data Input Interface for collecting voice samples, textual data, and personality traits.
A User Interface for live interaction via voice or text.
Cloud Storage for secure archiving of user data and conversation histories.
A Real-Time Processing Unit to enable seamless communication.
Security Protocols to protect privacy and data integrity.
API Integrations to connect with third-party tools, datasets, or media services.

This architecture allows the system to learn from user interactions, adapt conversational style over time, and deliver increasingly personalized and emotionally authentic exchanges.

### DESCRIPTION OF CERTAIN EMBODIMENTS

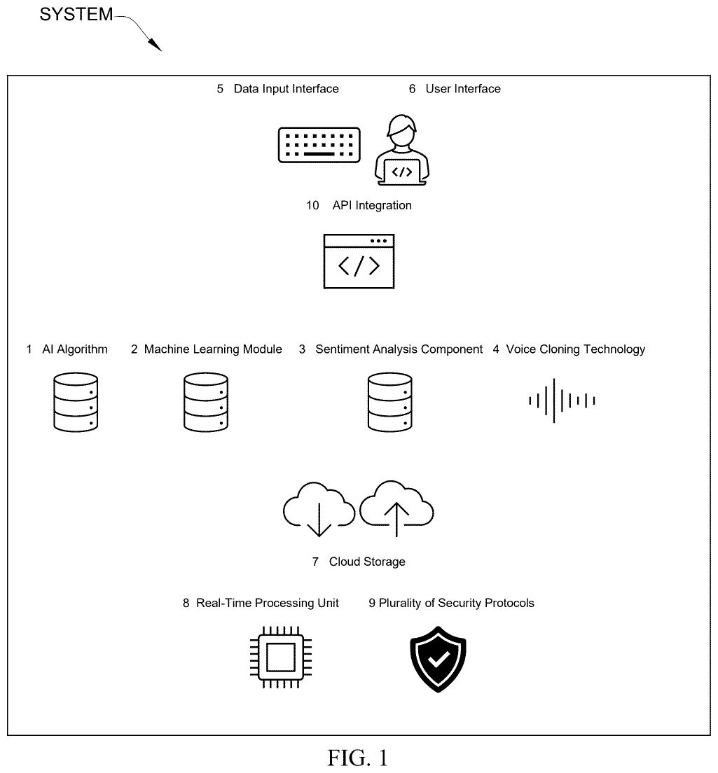

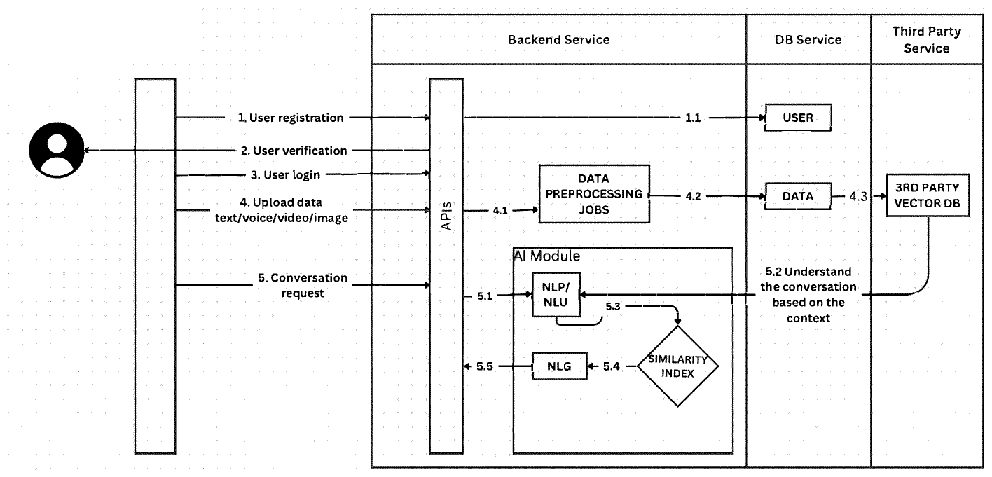

FIG. 1-2 illustrate example embodiments of the system. While specific configurations are described, variations and equivalents may be substituted without altering the essential functionality.

The system functions as a hybrid of proprietary modules and external services. The AI Algorithm Module orchestrates conversation flow. It incorporates a Natural Language Processing (NLP) submodule for understanding and a Natural Language Generation (NLG) submodule for producing responses.

The Machine Learning Module refines the AI model based on stored user interactions in Cloud Storage, continuously updating persona accuracy.

The Proprietary Sentiment Analysis Component evaluates the emotional tone of both user inputs and generated outputs, modifying responses to maintain empathy and realism.

The Voice Cloning Technology may be a proprietary development or a third-party integration, accessed through API Integration. This module recreates the unique voice profile of the deceased individual.

The Data Input Interface collects initial configuration data (e.g., biography, preferences, mannerisms, audio samples). This information feeds into both the Machine Learning Module and Voice Cloning Technology.

The User Interface—delivered via mobile app, web client, or hardware device—serves as the interaction point for conversations. It connects to the Real-Time Processing Unit, which manages latency and ensures synchronous communication.

Security Protocols ensure compliance with data protection regulations, including encryption at rest and in transit.

API Integration allows the platform to connect with external databases (e.g., vector search engines for semantic memory retrieval), third-party AI services, or multimedia content providers to enhance the conversational experience.

### Example Workflow

In operation, the process may follow these steps:
User Registration and profile creation.
Data Upload of text, images, audio, or video representing the deceased.
Persona Modeling using AI algorithms, sentiment analysis, and optional external knowledge sources.
Voice Synthesis using integrated voice cloning services.
Conversation Initiation through the User Interface.
Real-Time Dialogue with adaptive emotional and contextual responses.
Data Storage & Learning in Cloud Storage to improve future interactions.

### Alternative Applications

While designed for grief support, the system's modular architecture supports adaptation to other uses, including:
Therapeutic Applications: Virtual counseling simulations.
Education: Simulated dialogues with historical figures or experts.
Entertainment: Interactive storylines with fictional characters.
Customer Service: AI representatives with human-like empathy.
Healthcare: Companionship for patients in isolation.

### Product Ecosystem

The invention may also support:
Subscription-based conversation services.
Custom persona creation packages.
Integration with VR/AR for immersive experiences.
API licensing to third-party developers.

### Scope

The described embodiments are illustrative, not limiting. Variations in AI architecture, integration methods, or interface design are anticipated within the scope of the appended claims.

What is claimed is:

1. A system configured to provide a service to a user leveraging artificial intelligence (AI) and machine learning to provide at least one simulated conversation with a deceased individual, the system comprising: at least one AI algorithm configured to power conversation simulation; a machine learning module configured to learn from at least one past interaction; a sentiment analysis component configured to analyze and integrate emotional context into responses; a voice cloning technology configured to recreate a voice of the deceased individual; a data input interface configured to receive user-provided information about the deceased individual; a user interface configured to facilitate interactions between the user and the system; a cloud storage configured to store user data and conversation histories securely; a real-time processing unit configured to manage interactive sessions; a plurality of security protocols configured to protect user data and ensure privacy; and an application programming interface (API) integration configured to connect with one or more external systems for data enhancement and additional functionality.

2. The system of claim 1, wherein the sentiment analysis component comprises a third-party sentiment analysis service integrated via the API.

3. The system of claim 1, wherein the voice cloning technology comprises a third-party voice cloning service integrated via the API.

4. The system of claim 1, wherein the system is further configured to selectively switch between proprietary and third-party sentiment analysis modules based on performance or user preference.

5. The system of claim 1, wherein the API integration is configured to connect to multiple external services for data enrichment, including text-based datasets, voice archives, and multimedia sources.

6. The system of claim 1, wherein the machine learning module is trained using both stored user data and data retrieved from one or more external sources via the API integration.
